(19) United States
(12) Patent Application Publication
(10) Pub. No.: US 2015/0375582 A1
(43) Pub. Date: Dec. 31, 2015

(54) FLEXIBLE TIRE VALVE HAVING REINFORCED INNER FRAME

(71) Applicant: E-LEAD ELECTRONIC CO., LTD., Changhua (TW)

(72) Inventor: Stephen Chen, Changhua (TW)

(21) Appl. No.: 14/320,160

(22) Filed: Jun. 30, 2014

(51) Int. Cl. B60C 23/04; B60C 29/00

(52) U.S. Cl. CPC B60C 23/0494; B60C 29/005

(57) ABSTRACT

A flexible tire valve having reinforced inner frame is disclosed. The flexible tire valve comprises a tube body, a reinforced inner frame and a flexible sleeve. When the reinforced inner frame is inserted into the flexible sleeve, the first blocking edge of the reinforced inner frame is engaged with the inner groove of the flexible sleeve; and the upper edge of the first clamping part of the reinforced inner frame presses against the second clamping part of the flexible sleeve to reinforce the flexible sleeve in order to further fix the flexible sleeve in order to prevent the flexible tire valve from being skewed by the centrifugal force, whereby the tire will not leak even if the vehicle moves at high speed.

### BACKGROUND OF THE INVENTION

(a) Field of the Invention

The present invention generally relates to a flexible tire valve having a reinforced inner frame, in particular to a flexible tire valve can effectively prevent the tire of a vehicle from leaking when the vehicle moves at high speed, whereby the flexible tire valve will not be skewed by the centrifugal force and the durability of the tire valve against the centrifugal force can be further enhanced, such that the tire will not leak even if the vehicle moves at high speed.

(b) Description of the Prior Art

Safe driving is subject to stable tire pressure; therefore, the tire pressure monitor (or device) has become an important accessory for a car. In general, the tire pressure monitor is usually installed on the tire valve of a wheel. In order to achieve weight reduction, the material of tire valve is usually made of aluminum instead of copper. However, in temperature and cold zones, it is inclined to snow in winter; therefore, people will spread salt over roads in order to remove snow from the roads. The tire valve made of aluminum may be eroded by salt, which may result in the aging of the tire valve and tire leak.

The rubber tire valve shown in FIG. 1 is designed to solve the above problem. There is a copper tube 11 disposed inside the tire valve, and the copper tube 11 is covered by a rubber sleeve 12. The rubber sleeve 12 is disposed with the blocking edge 13 for engaging with a wheel rim in order to make sure the inner side of the tire valve fit over the inner surface of the wheel rim. The copper tube 11 is further disposed with the external thread portion 111 for engaging with a corresponding internal thread portion 141 inside the valve cover 14. In addition to the above configuration, the pressure from the tire will further fix the valve cover 14 to prevent from tire leak. Similar devices are disclosed by TW 13344539, TW M312444, TW 1388752 and TW publication No. 201343429, etc.

The above conventional devices can actually solve some problems about tire leak. However, if the vehicle moves at high speed, the aforementioned rubber tire valve 1 will be pressed toward the inside of the wheel by the centrifugal force, and the force that the groove 13 engages with the wheel rim and the force from the tire pressure will also be cancelled by the centrifugal force, so that the inner surface of the rubber tire valve 1 cannot tightly fit over the inner surface of the wheel rim, which will result in tire leak. Thus, rubber valves are not suitable for vehicles moving at high speed, especially for those moving at the no-speed-limit German freeway.

### SUMMARY OF THE INVENTION

In order to overcome the shortcomings of the prior art, the inventor keeps on carving unflaggingly through wholehearted experience and research to develop the present invention, which can effectively improve the defects described above. In other words, it is a primary objective of the present invention to provide a flexible tire valve having a reinforced inner frame can effectively prevent the tire of a vehicle from leaking when the vehicle moves at high speed, whereby the flexible tire valve will not be skewed by the centrifugal force and the durability of the tire valve against the centrifugal force can be further enhanced, such that the tire will not leak even if the vehicle moves at high speed.

To achieve the foregoing objective, the present invention provides a flexible tire valve. The flexible tire valve may comprise a tube body, a reinforced inner frame and a flexible sleeve. The tube body may be made of metal. The reinforced inner frame may be hollow, and the outer surface of the reinforced inner frame may be disposed with a first blocking edge and a first clamping edge. The flexible sleeve may be hollow, and the tube body may be capped by the flexible sleeve; the outer surface of the flexible sleeve may be disposed with a second blocking edge, a slot and a second clamping part, wherein when the slot is engaged with a wheel rim, the bottom of the second blocking edge may press against the outer surface of the wheel rim, and the upper edge of the second clamping part may press against the inner surface of the wheel rim; and the flexible sleeve may have an inner hole, and the inner hole may be disposed with an inner groove. When the reinforced inner frame is inserted into the flexible sleeve, the first blocking edge may be engaged with the inner groove and the upper edge of the first clamping part may press against the second clamping part to reinforce the flexible sleeve in order to further fix the flexible sleeve.

In a preferred embodiment of the present invention, the outer surface of the reinforced inner frame may be further disposed with a gap.

In a preferred embodiment of the present invention, the upper portion of the reinforced inner frame may be further disposed with a plurality of gaps.

In a preferred embodiment of the present invention, the flexible tire valve may further comprise a collar, wherein the flexible sleeve may further comprise a third blocking edge, and when the flexible tire valve is installed on the wheel rim, the collar may fit tightly around the flexible sleeve and the top of the collar may press against the third blocking edge and the bottom of the collar may press against the outer surface of the wheel rim.

In a preferred embodiment of the present invention, the outer surface of the collar may be further disposed with a gap.

In a preferred embodiment of the present invention, the upper portion of the collar may be further disposed with a plurality of gaps.

To achieve the foregoing objective, the present invention further provides a tire pressure detecting device having flexible tire valve with reinforced inner frame. The tire pressure detecting device may comprise a tube body, a flexible sleeve and a tire pressure detecting device. The tube body may be made of metal. The flexible sleeve may be hollow, and the tube body may be capped by the flexible sleeve; the outer surface of the flexible sleeve may be disposed with a second blocking edge, a slot and a second clamping part, wherein when the slot is engaged with a wheel rim, the bottom of the second blocking edge may press against the outer surface of the wheel rim, and the upper edge of the second clamping part may press against the inner surface of the wheel rim; and the flexible sleeve may have an inner hole, and the inner hole may be disposed with an inner groove. The tire pressure detecting device can detect the tire pressure of a vehicle, wherein the casing of the tire pressure detecting device may be combined with a reinforced inner frame, and the reinforced inner frame may be hollow, and the outer surface of the reinforced inner frame may be disposed with a first blocking edge and a first clamping edge, and the first blocking edge may be engaged with the inner groove and the upper edge of the first clamping part may press against the second clamping part to reinforce the flexible sleeve in order to further fix the flexible sleeve.

In a preferred embodiment of the present invention, the outer surface of the reinforced inner frame may be further disposed with a gap.

In a preferred embodiment of the present invention, the upper portion of the reinforced inner frame may be further disposed with a plurality of gaps.

In a preferred embodiment of the present invention, the tire pressure detecting device may further comprise a spring, wherein the spring may be an antenna.

In a preferred embodiment of the present invention, the tire pressure detecting device may further comprise a collar, wherein the flexible sleeve may further comprise a third blocking edge, and when the flexible tire valve may be installed on the wheel rim, the collar may fit tightly around the flexible sleeve and the top of the collar may press against the third blocking edge and the bottom of the collar may press against the outer surface of the wheel rim.

In a preferred embodiment of the present invention, the outer surface of the collar may be further disposed with a gap.

In a preferred embodiment of the present invention, the upper portion of the collar may be further disposed with a plurality of gaps.

### BRIEF DESCRIPTION OF THE DRAWINGS

The detailed structure, operating principle and effects of the present invention will now be described in more details hereinafter with reference to the accompanying drawings that show various embodiments of the invention as follows.

FIG. 1 is a 3D exploded view of a conventional rubber tire valve.

FIG. 2 is a 3D exploded view of the present invention.

FIG. 3 is a cross-sectional view of the present invention.

FIG. 4 is a 3D exploded view of the present invention with a collar.

FIG. 5 is a cross-sectional view of the embodiment of FIG. 4 in accordance with the present invention.

FIG. 6 is a schematic view of the embodiment two of a collar in accordance with the present invention.

FIG. 7 is a schematic view of the embodiment three of a collar in accordance with the present invention.

FIG. 8 is a schematic view of the embodiment two of a reinforced inner frame in accordance with the present invention.

FIG. 9 is a schematic view of the embodiment three of a reinforced inner frame in accordance with the present invention.

FIG. 10 is a schematic view of the embodiment one of the present invention combined with a tire pressure detecting device.

FIG. 11 is a schematic view of the embodiment two of the present invention combined with a tire pressure detecting device.

FIG. 12 is a cross-sectional view of the embodiment of FIG. 11 in accordance with the present invention.

FIG. 13 is a schematic view of the embodiment three of the present invention combined with a tire pressure detecting device.

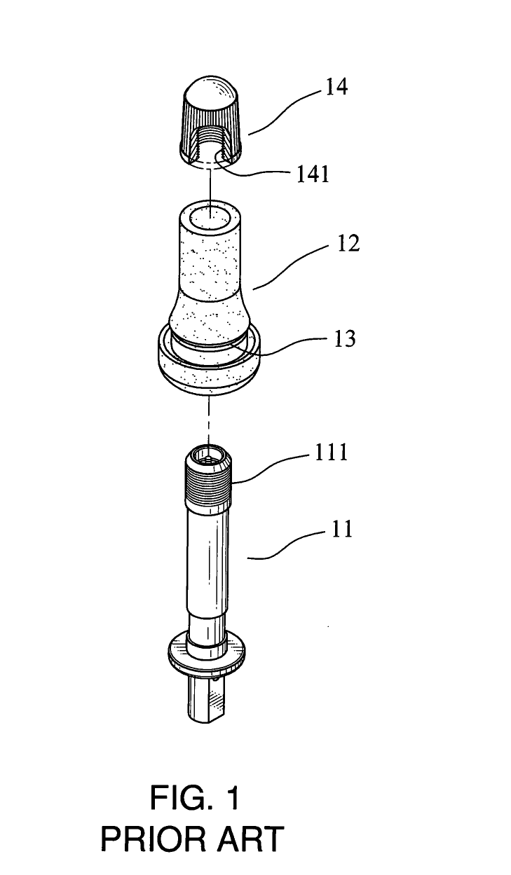

### DETAILED DESCRIPTION OF THE PREFERRED EMBODIMENTS

The technical content of the present invention will become apparent by the detailed description of the following embodiments and the illustration of related drawings as follows.

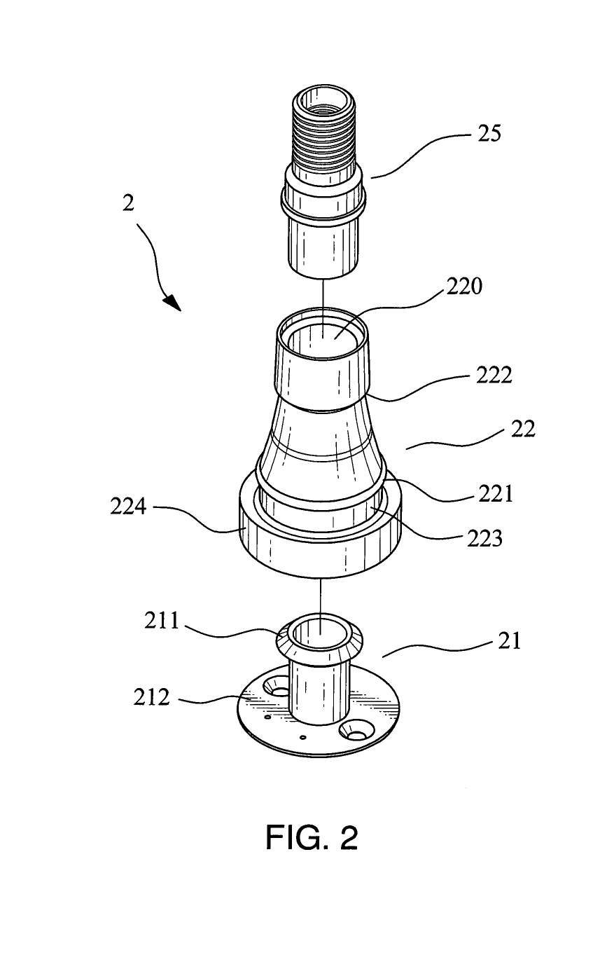

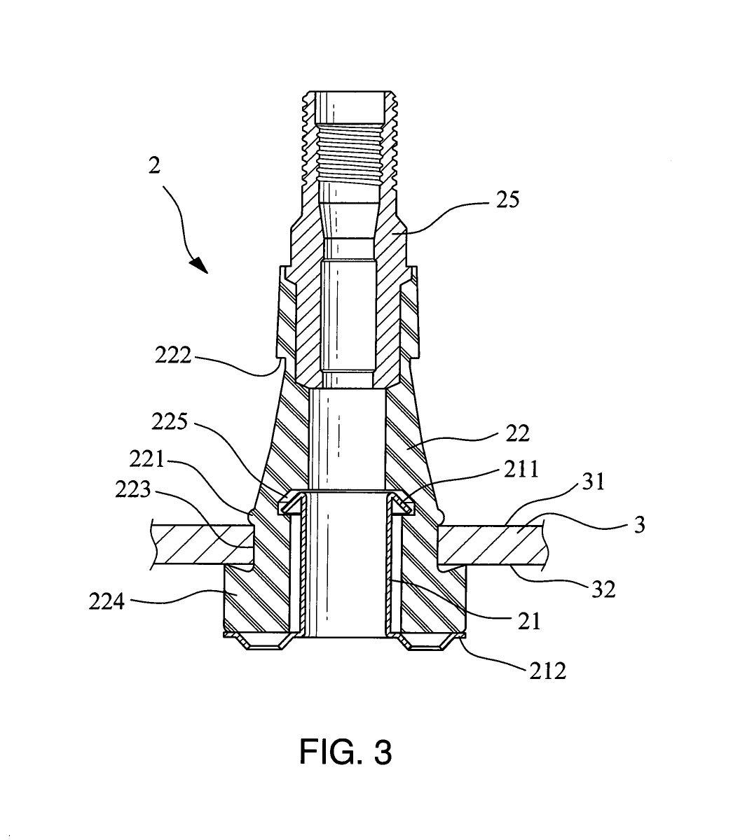

With reference to FIG. 2 and FIG. 3 for the embodiment of a reinforced tire valve 2 of a tire pressure detecting device A in accordance with the present invention, the reinforced tire valve 2 comprises a tube body 25, a reinforced inner frame 21 and a flexible sleeve 22.

The tube body 25 is made of metal. The reinforced inner frame 21 is hollow, and made of metal or other hard materials, and the outer surface of the reinforced inner frame 21 is disposed with a first blocking edge 211 and a first clamping edge 212. The flexible sleeve 22 is hollow, and the tube body 25 is capped by the flexible sleeve 22. The outer surface of the flexible sleeve 22 is disposed with a second blocking edge 211, a slot 223 and a second clamping part 224, wherein when the slot 223 is engaged with a wheel rim 3, the bottom of the second blocking edge 211 presses against the outer surface 31 of the wheel rim 3, and the upper edge of the second clamping part 224 presses against the inner surface 32 of the wheel rim 3. The flexible sleeve 22 has an inner hole 220, and the inner hole 220 is disposed with an inner groove 225.

When the reinforced inner frame 21 is inserted into the flexible sleeve 22, the first blocking edge 211 is engaged with the inner groove 225 and the upper edge of the first clamping part 212 presses against the second clamping part 224 to reinforce the flexible sleeve 22 in order to further fix the flexible sleeve 22.

The flexible sleeve 22 further comprises a third blocking edge 222.

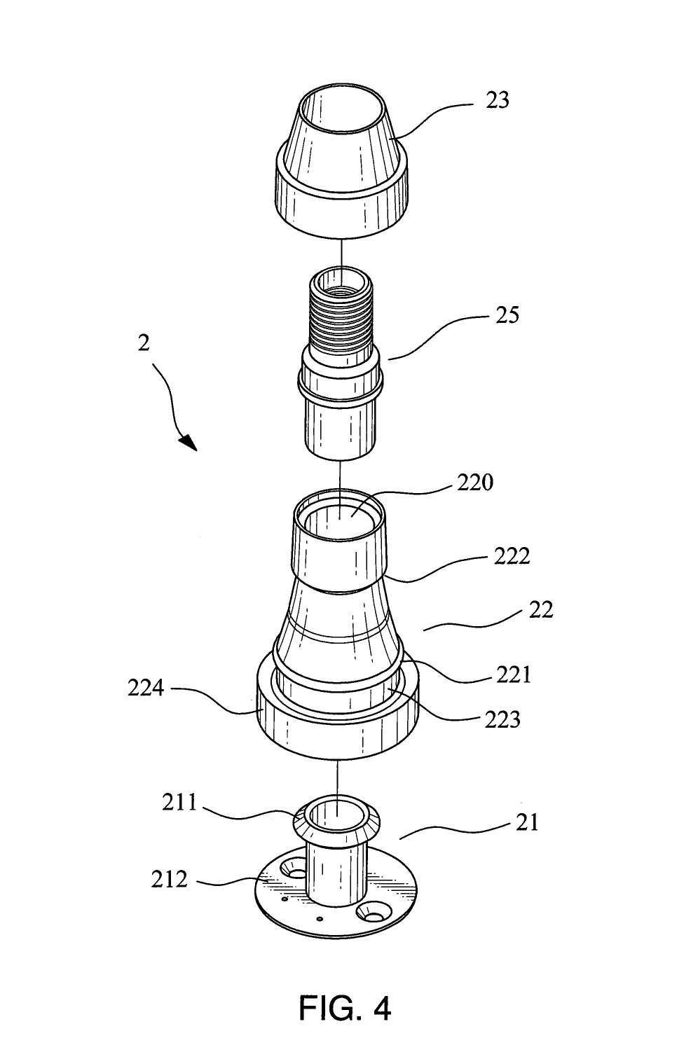

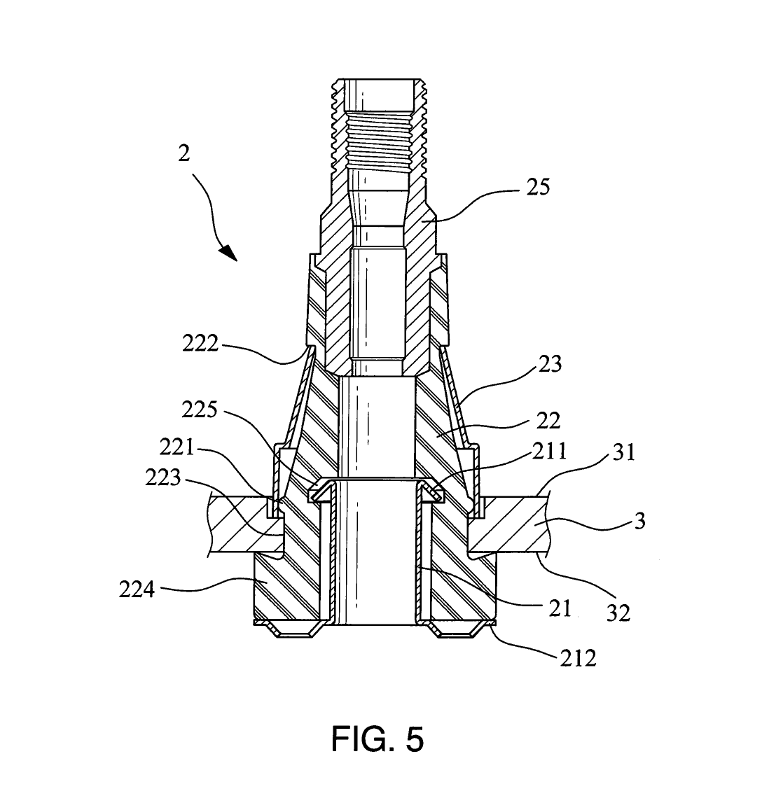

The flexible sleeve 22 further comprises a collar 23 (as shown in FIG. 4 and FIG. 5), and the collar 23 is made of metal or other hard materials. When the flexible tire valve 2 is installed on the wheel rim 3, the collar 23 fits tightly around the flexible sleeve 22 and the top of the collar 23 presses against the third blocking edge 222 and the bottom of the collar 23 presses against the outer surface 31 of the wheel rim 3.

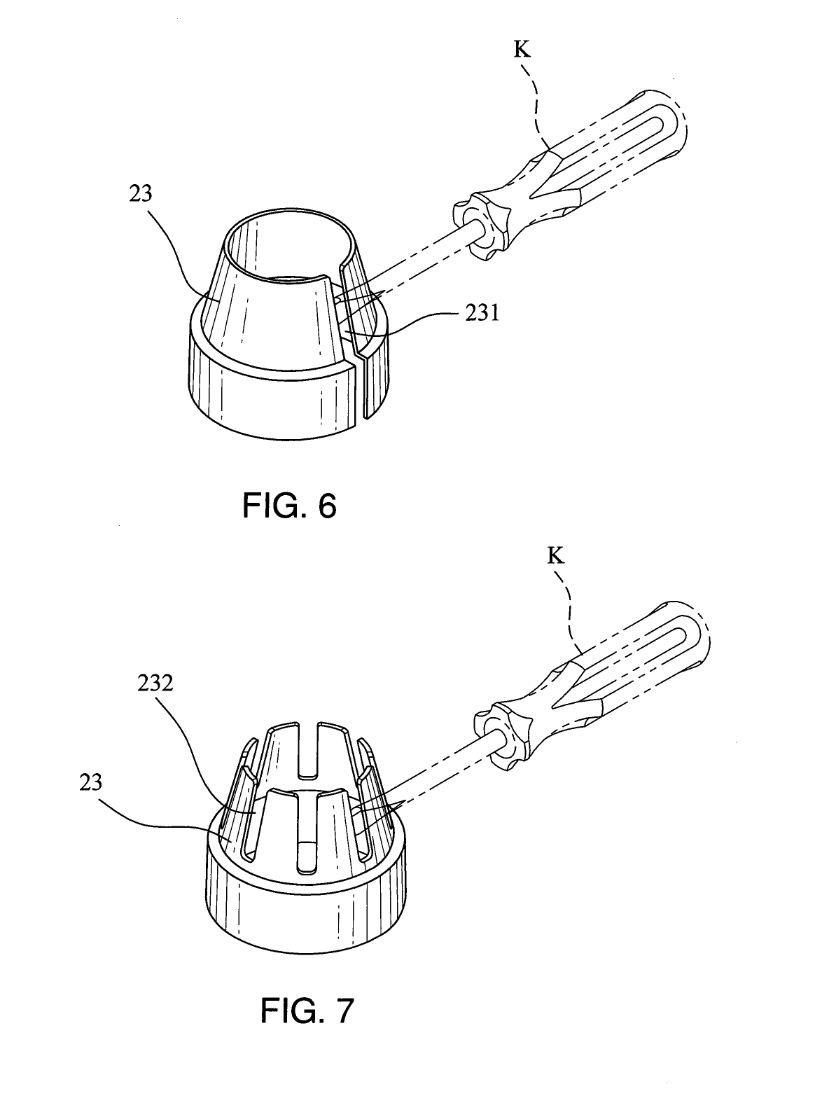

With reference to FIG. 6 for the embodiment two of a collar 23 in accordance with the present invention, the outer surface of the collar 23 is further disposed with a gap 231. When disassembling the flexible tire valve 2, the user can insert a flathead screwdriver K into the gap 231 to pull open the collar 23 to remove the collar 23.

With reference to FIG. 7 for the embodiment three of a collar 23 in accordance with the present invention, the upper portion of the collar 23 is further disposed with a plurality of gaps 232. When disassembling the flexible tire valve 2, the user can insert a flathead screwdriver K into one of the gaps 232 to pull open the upper portion of the collar 23 to remove the collar 23.

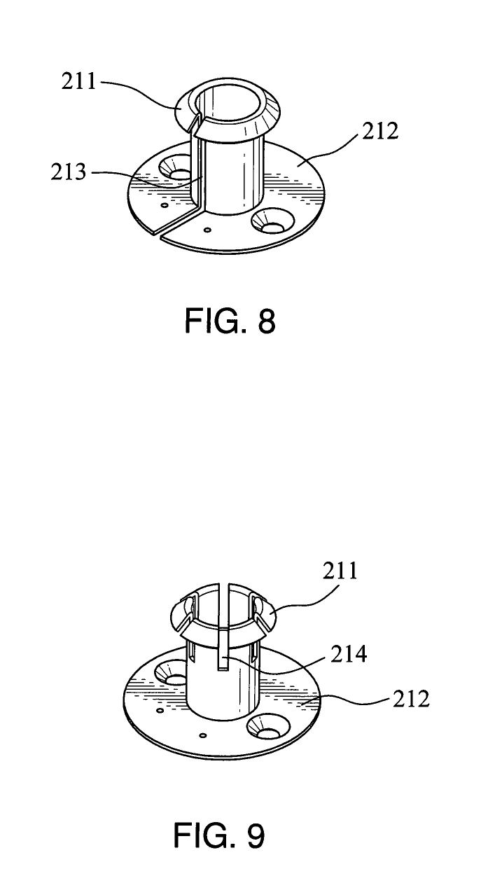

With reference to FIG. 8 for the embodiment two of a reinforced inner frame 21 in accordance with the present invention, the outer surface of the reinforced inner frame 21 is further disposed with a gap 213.

With reference to FIG. 9 for the embodiment three of a reinforced inner frame 21 in accordance with the present invention, the upper portion of the reinforced inner frame 21 is further disposed with a plurality of gaps 214.

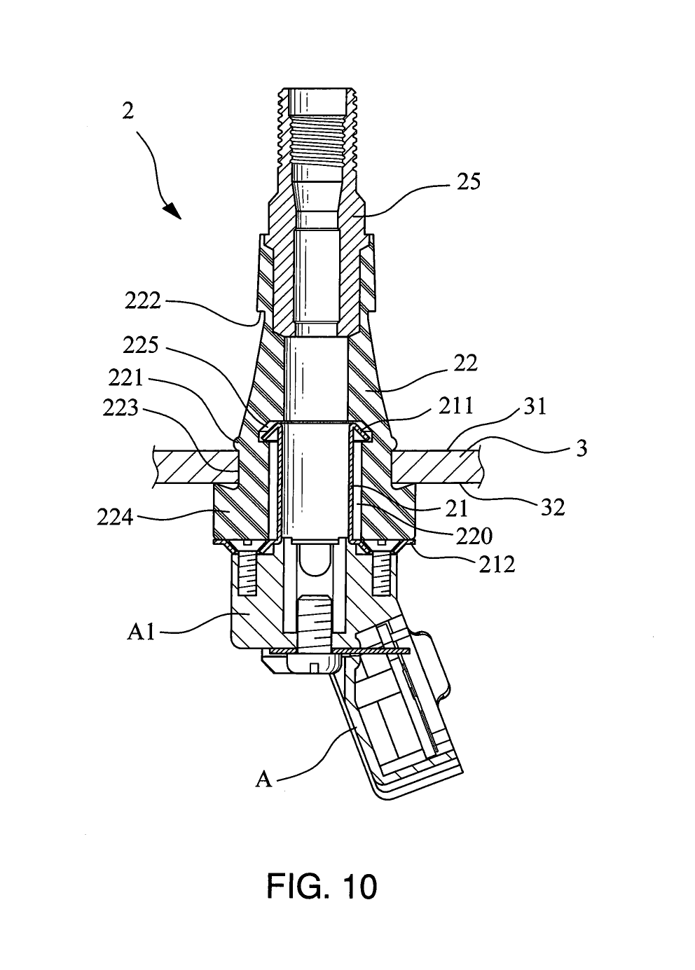

With reference to FIG. 10 for the embodiment of a flexible tire valve 2 having a reinforced inner frame in accordance with the present invention combined with a tire pressure detecting device A, the flexible tire valve 2 comprises a tube body 25, a flexible sleeve 22 and a tire pressure detecting device A. The tube body 25 is made of metal. The flexible sleeve 22 is hollow, and made of rubber, and the tube body 25 is capped by the flexible sleeve 22. The outer surface of the flexible sleeve 22 is disposed with a second blocking edge 211, a slot 223 and a second clamping part 224, wherein when the slot 223 is engaged with a wheel rim 3, the bottom of the second blocking edge 211 presses against the outer surface 31 of the wheel rim 3, and the upper edge of the second clamping part 224 presses against the inner surface 32 of the wheel rim 3. The inner hole 220 of the flexible sleeve 22 is disposed with an inner groove 225. The tire pressure detecting device A can detect the tire pressure of a vehicle, wherein the casing Al of the tire pressure detecting device A is combined with a reinforced inner frame 21. The reinforced inner frame 21 is hollow, and made of metal or other hard materials, and the outer surface of the reinforced inner frame 211 is disposed with a first blocking edge 211 and a first clamping edge 212, and the first blocking edge 211 is engaged with the inner groove 225 and the upper edge of the first clamping part 212 presses against the second clamping part 221 to reinforce the flexible sleeve 22 in order to further fix the flexible sleeve 22.

The flexible sleeve 22 further comprises a third blocking edge 222.

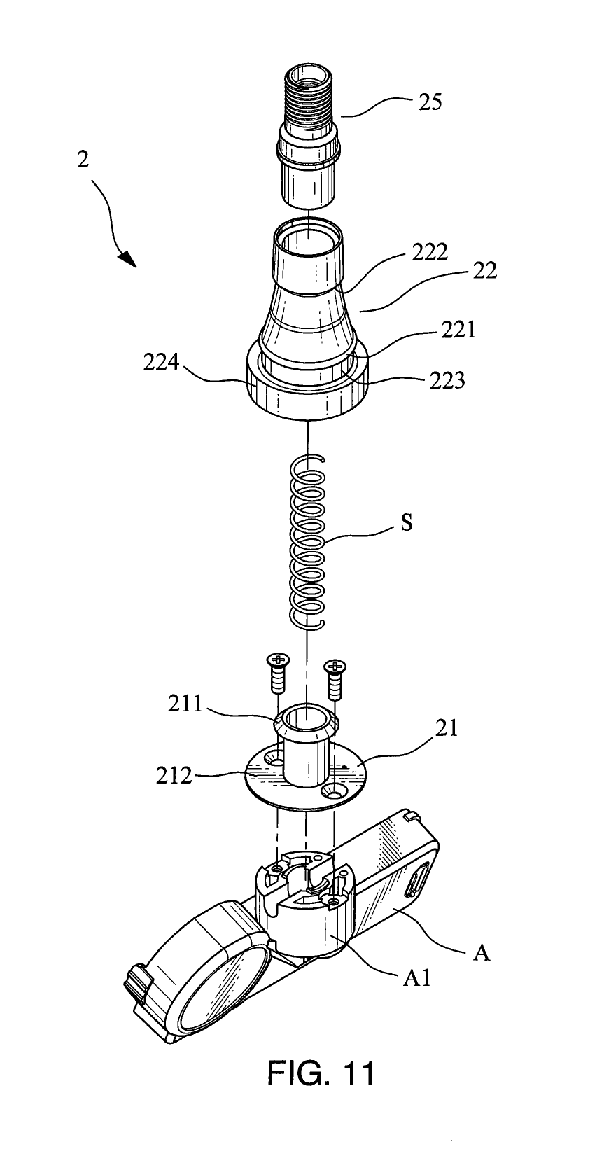

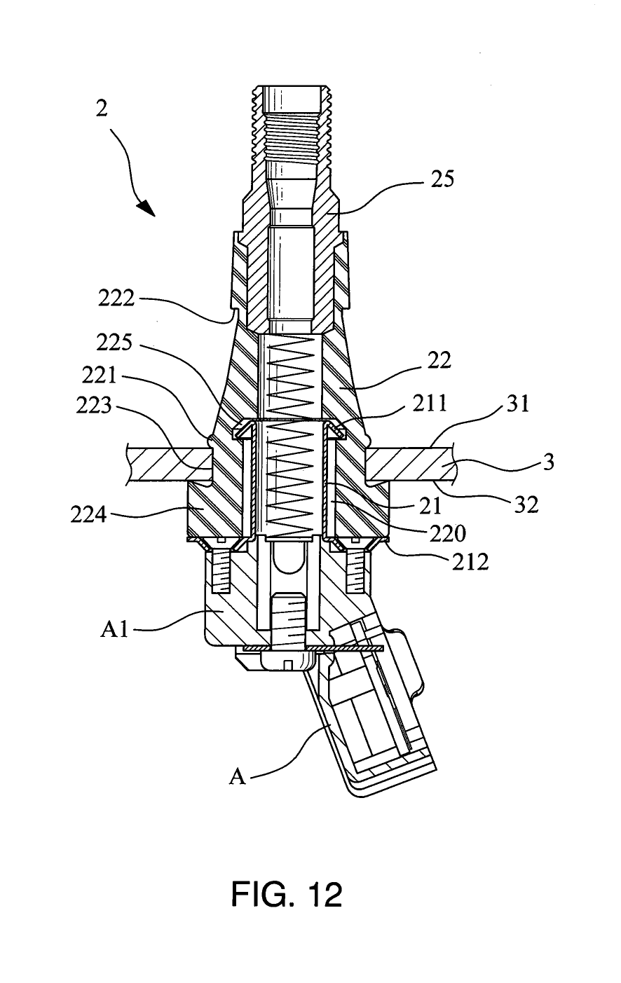

With reference to FIG. 11 and FIG. 12 for another embodiment of a tire pressure detecting device A having flexible tire valve 3 with reinforced inner frame in accordance with the present invention, the tire pressure detecting device A further comprises a spring S, wherein the spring S is an antenna and disposed in the flexible sleeve 22.

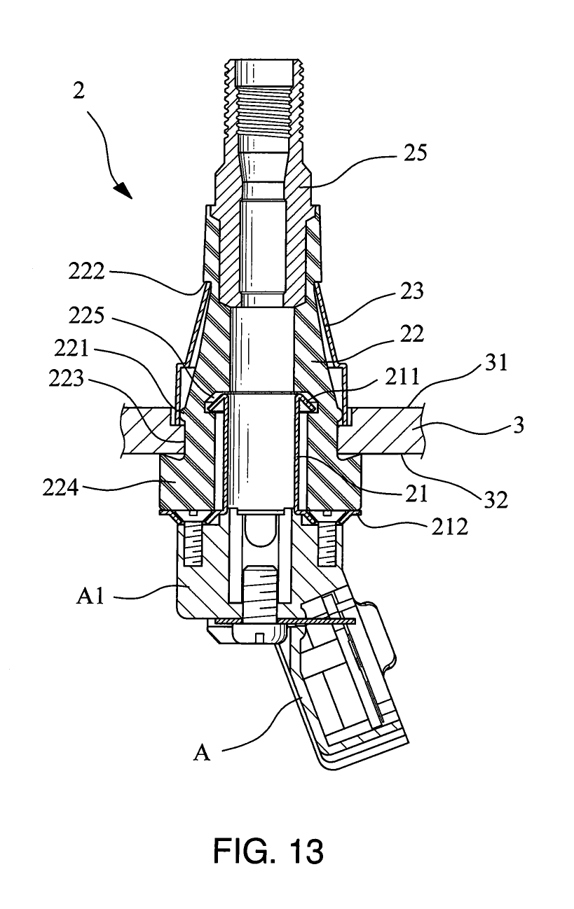

In another embodiment of a tire pressure detecting device A having a flexible tire valve 2 with a reinforced inner frame in accordance with the present invention, the flexible tire valve 2 further comprises a collar 23 (as shown in FIG. 13), wherein the collar 23 is made of metal or other hard materials. When the flexible tire valve 2 is installed on the wheel rim 3, the collar 23 fits tightly around the flexible sleeve 22 and the top of the collar 23 presses against the third blocking edge 222 and the bottom of the collar 23 presses against the outer surface 31 of the wheel rim 3.

FIG. 6 shows the embodiment two of the collar 23 of the above embodiment, wherein the outer surface of the collar 23 is further disposed with a gap 231. When disassembling the flexible tire valve 2, the user can insert a flathead screwdriver K into the gap 231 to easily pull open the collar 23 to remove the collar 23.

FIG. 7 shows the embodiment three of the collar 23 of the above embodiment, wherein the upper portion of the collar 23 is further disposed with a plurality of gaps 232. When disassembling the flexible tire valve 2, the user can insert a flathead screwdriver K into one of the gaps 232 to easily pull open the upper portion of the collar 23 to remove the collar 23.

FIG. 8 shows the embodiment two of a reinforced inner frame 21 of the above embodiment, wherein the outer surface of the reinforced inner frame 21 is further disposed with a gap 213.

FIG. 9 shows the embodiment three of a reinforced inner frame 21 of the above embodiment, wherein the upper portion of the reinforced inner frame 21 is further disposed with a plurality of gaps 214.

The above embodiments of the present invention use the reinforced inner frame 21 to strengthen the durability of the flexible tire valve 2 against the centrifugal force, wherein the first blocking edge 211 is engaged with the inner groove 225 and the top of the first clamping part 212 presses against the second clamping part 224 to strengthen the flexible sleeve 22 in order to further fix the flexible sleeve 22, which can not only prevent the flexible sleeve 22 from being twisted out of shape due to aging, but also can directly impose the torsional force generated from the centrifugal force to the flexible sleeve 22 and indirectly impose which on the wheel rim 3 to prevent the tire valve from be skewed by the centrifugal force. Besides, the collar 23 can further reinforce the flexible sleeve 22, such that the inside and the outside of the flexible tire valve are tightly clamped to enhance its firmness and prevent the tire valve from be skewed by the centrifugal force. Accordingly, the tire will not leak even if the vehicle moves at high speed.

While the means of specific embodiments in present invention has been described by reference drawings, numerous modifications and variations could be made thereto by those skilled in the art without departing from the scope and spirit of the invention set forth in the claims. The modifications and variations should in a range limited by the specification of the present invention.

What is claimed is:

1. A flexible tire valve having reinforced inner frame, comprising:
a tube body, wherein the tube body is made of metal;
a reinforced inner frame, wherein the reinforced inner frame is hollow, and an outer surface of the reinforced inner frame is disposed with a first blocking edge and a first clamping edge; and
a flexible sleeve, wherein the flexible sleeve is hollow, and the tube body is capped by the flexible sleeve; an outer surface of the flexible sleeve is disposed with a second blocking edge, a slot and a second clamping part, wherein when the slot is engaged with a wheel rim, a bottom of the second blocking edge presses against an outer surface of the wheel rim, and an upper edge of the second clamping part presses against an inner surface of the wheel rim; and the flexible sleeve has an inner hole, and the inner hole is disposed with an inner groove;
wherein when the reinforced inner frame is inserted into the flexible sleeve, the first blocking edge is engaged with the inner groove and an upper edge of the first clamping part presses against the second clamping part to reinforce the flexible sleeve in order to further fix the flexible sleeve.

2. The flexible tire valve having reinforced inner frame of claim 1, wherein the outer surface of the reinforced inner frame is further disposed with a gap.

3. The flexible tire valve having reinforced inner frame of claim 1, wherein an upper portion of the reinforced inner frame is further disposed with a plurality of gaps.

4. The flexible tire valve having reinforced inner frame of claim 1, further comprising a collar, wherein the flexible sleeve further comprises a third blocking edge, and when the flexible tire valve is installed on the wheel rim, the collar fits tightly around the flexible sleeve and a top of the collar presses against the third blocking edge and a bottom of the collar presses against the outer surface of the wheel rim.

5. The flexible tire valve having reinforced inner frame of claim 1, further comprising a collar, wherein an outer surface of the collar is further disposed with a gap.

6. The flexible tire valve having reinforced inner frame of claim 1, further comprising a collar, wherein an upper portion of the collar is further disposed with a plurality of gaps.

7. A tire pressure detecting device having flexible tire valve with reinforced inner frame, comprising:
a tube body, wherein the tube body is made of metal;
a flexible sleeve, wherein the flexible sleeve is hollow, and the tube body is capped by the flexible sleeve; an outer surface of the flexible sleeve is disposed with a second blocking edge, a slot and a second clamping part, wherein when the slot is engaged with a wheel rim, a bottom of the second blocking edge presses against an outer surface of the wheel rim, and an upper edge of the second clamping part presses against an inner surface of the wheel rim; and the flexible sleeve has an inner hole, and the inner hole is disposed with an inner groove;
a tire pressure detecting device, for detecting a tire pressure of a vehicle, wherein a casing of the tire pressure detecting device is combined with a reinforced inner frame, and the reinforced inner frame is hollow, and an outer surface of the reinforced inner frame is disposed with a first blocking edge and a first clamping edge, and the first blocking edge is engaged with the inner groove and an upper edge of the first clamping part presses against the second clamping part to reinforce the flexible sleeve in order to further fix the flexible sleeve.

8. The tire pressure detecting device having flexible tire valve with reinforced inner frame of claim 7, wherein the outer surface of the reinforced inner frame is further disposed with a gap.

9. The tire pressure detecting device having flexible tire valve with reinforced inner frame of claim 7, wherein an upper portion of the reinforced inner frame is further disposed with a plurality of gaps.

10. The tire pressure detecting device having flexible tire valve with reinforced inner frame of claim 7, further comprising a spring, wherein the spring is an antenna.

11. The tire pressure detecting device having flexible tire valve with reinforced inner frame of claim 7, further comprising a collar, wherein the flexible sleeve further comprises a third blocking edge, and when the flexible tire valve is installed on the wheel rim, the collar fits tightly around the flexible sleeve and a top of the collar presses against the third blocking edge and a bottom of the collar presses against the outer surface of the wheel rim.

12. The tire pressure detecting device having flexible tire valve with reinforced inner frame of claim 7, further comprising a collar, wherein an outer surface of the collar is further disposed with a gap.

13. The tire pressure detecting device having flexible tire valve with reinforced inner frame of claim 7, further comprising a collar, wherein an upper portion of the collar is further disposed with a plurality of gaps.
